(19) United States
(12) Patent Application Publication
(10) Pub. No.: US 2025/0075430 A1
(43) Pub. Date: Mar. 6, 2025

(54) THERMALLY ACTIVATED BIOBASED POLYMERIC COATING COMPOSITIONS ON PAPER AND PAPERBOARD SUBSTRATES

(71) Applicant: SOLENIS TECHNOLOGIES, L.P., Wilmington, DE (US)

(72) Inventors: Ramakrishna Trovagunta, Glen Mills, PA (US); Cecil Carrido, Wilmington, DE (US)

(73) Assignee: SOLENIS TECHNOLOGIES, L.P., Wilmington, DE (US)

(21) Appl. No.: 18/825,009

(22) Filed: Sep. 5, 2024

Related U.S. Application Data
(60) Provisional application No. 63/580,737, filed on Sep. 6, 2023.

(51) Int. Cl. D21H 19/12; C09D 101/32; D21H 21/16

(52) U.S. Cl. CPC D21H 19/12; C09D 101/32; D21H 21/16

(57) ABSTRACT

A number of variations may include depositing, on a substrate comprising cellulose, an aqueous mixture comprising modified cellulose polymer molecules and organic acid molecules comprising at least two carboxyl acid groups; removing water from the mixture deposited on the substrate to provide a coating on the substrate; wherein the organic acid molecules have a melting point above ambient temperature, and wherein the organic acid molecules are cross-linkable with the modified cellulose polymer molecules and the cellulose at or above ambient temperatures.

### CROSS REFERENCE TO RELATED APPLICATIONS

This application claims the benefit of the U.S. Provisional Ser. No. 63/580,737 filed Sep. 6, 2023.

### TECHNICAL FIELD

The field to which the disclosure generally relates to methods, and products involving, having, or made from thermally activated biobased polymeric coating compositions.

### BACKGROUND

Synthetic polymers derived from fossil fuels have been the primary choice for food packaging for several years. These plastics have become popular due to their exceptional thermal and mechanical properties, ability to retain heat, ease of use, flexibility, cost-effectiveness, and resistance to air, moisture, oil, and grease. However, due to the high demand for plastics, fossil fuels are becoming depleted, and non-biodegradable waste management has led to environmental concerns. The excessive use of plastics has resulted in a worldwide waste disposal crisis.

In the past decade, a number of biobased alternatives from renewable materials and or biodegradable sources have been proposed for food packaging applications. While biobased materials lead to the design of more sustainable products, there are several drawbacks as compared to plastics: (1) poor durability of bio-based materials resulting in reduced shelf-life; (2) significant modifications of existing manufacturing processes are necessary; (3) higher cost of biobased polymers compared to plastics; and (4) significantly lower performances of bio-based comparing to synthetic polymers. For example, despite being biodegradable long-chain polymers, polysaccharides tend to be limited by their hydrophilic nature resulting in low compatibility in hydrophobic and non-polar matrices.

The challenges around the use of biobased polymeric coatings for food packaging applications stem from the fact that most materials have limited hydrophobic and/or oleophobic characteristics that are critical for oil-grease applications. Therefore, a combination of biobased materials with synthetic polymers are often explored and applied in the commercial realm.

Accordingly, it is desirable to have oleophobic characteristics on the paper substrate for food packaging. In addition, it is desirable to have the oleophobes applied to the paper substrate with the existing technology. Furthermore, other desirable features and characteristics of the present disclosure will become apparent from the subsequent detailed description and the appended claims, taken in conjunction with the accompanying drawings and this background.

### SUMMARY OF ILLUSTRATIVE VARIATIONS

A number of variations may include a method comprising: depositing, on a substrate comprising cellulose, an aqueous mixture comprising modified cellulose polymer molecules and organic acid molecules comprising at least two carboxyl acid groups; removing water from the mixture deposited on the substrate to provide a coating on the substrate; wherein the organic acid molecules have a melting point above ambient temperature, and wherein the organic acid molecules are cross-linkable with the modified cellulose polymer molecules and the cellulose at or above ambient temperatures.

A number of variations may include a product comprising: a substrate having a cross-linked coating thereon, the substrate comprising cellulose, the cross-linked coating being the cross-linked reaction product of modified cellulose polymer molecules, organic acid molecules, and the cellulose, wherein the organic acid molecules comprising at least two carboxyl acid groups.

A number of variations may include a product comprising: an aqueous mixture comprising modified cellulose polymer molecules and organic acid molecules comprising at least two carboxyl acid groups on a substrate comprising cellulose, and wherein the organic acid molecules have a melting point above ambient temperature, and wherein the organic acid molecules have a cross linking property with the modified cellulose polymer molecules and or cellulose.

Other illustrative variations within the scope of the invention will become apparent from the detailed description provided hereinafter. It should be understood that the detailed description and specific examples while disclosing variations of the invention, are intended for illustration only and not to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a graph produced via ATR-FTIR showing the esterification between the paper, citric acid and HPMC according to a variation.

FIG. 2 illustrates a product according to a number of variations.

### DETAILED DESCRIPTION OF ILLUSTRATIVE VARIATIONS

The following description of the variations is merely illustrative in nature and is in no way intended to limit the scope of the invention, its application, or its uses.

The terms “about,” “approximate,” or “around” as used herein in association with or in respect to amounts or values shall mean a difference up to 10%, alternatively up to 5%, alternatively up to 1% of the recited amounts or values. Alternatively, the terms “about”, “approximate,” or “around” as used herein, shall mean up to an error value associated with conventional measuring devices used to measure a recited parameter.

The term “biobased polymer,” as used herein, refers to polymeric materials where at least a part is derived from naturally occurring renewable sources or biomasses.

Cellulose is a naturally occurring renewable and biodegradable biopolymeric material. Packaging films and coatings developed from such biopolymeric materials and or biobased polymer-derived plastics have demonstrated oxygen barrier performance at moderate humidity conditions alongside good tensile properties. However, the major limitations of coatings and films of cellulosic materials are their hydrophilic properties. A combination of cellulosics with crosslinkers and fillers can impart oleophilic and hydrophobic characteristics to the coatings to yield a strong barrier performance.

In a number of variations, modified cellulose materials may be cross-linked with naturally occurring organic acids into a paper sheet at (tunable) elevated temperatures. The activation energy for the cross-linking mechanism to commence can be controlled or tuned by the careful selection of organic acid and or combinations of organic acids. Different organic acids comprise of different melt points thereby imparting varying kinetic behavior to the esterification reaction.

The modified cellulose and organic acid blend may be unreactive during transport and storage while at ambient conditions. While unlikely, a small degree of the esterification reaction in storage and prior to coating application can occur but not so much as to result in gelling or an unacceptable increase in viscosity prior to coating application. The cellulose and acid do not need to be combined during transport. This simple blend can be coated and dried onto the sheet to create an excellent surface coating on the surface of the sheet.

Substrates including cellulosic material may have a wide variety of thicknesses, including but not limited to 5 microns to 5000 microns. A variety of paper substrates have been coated wherein the base sheet has ranged from 30 to 250 gram/m² (GSM). Additionally, papers made from virgin fibers, recycled fibers, as well as different wood species: hardwoods and softwoods were used. The type of paper onto which the coating was deposited was not a significant factor. The coating on each paper substrate achieved significant oleophobic characteristics.

In an exemplary embodiment, an aqueous mixture, including a modified cellulose and an organic acid, is deposited on the substrate. In embodiments, the modified cellulose is a cellulose ether. Hydroxyethyl cellulose, hydroxylpropyl cellulose, methyl cellulose and their derivatives are all examples of modified cellulose with increased solubility, reactivity and oleophobicity. In embodiments, hydroxypropyl methylcellulose (HPMC) is an excellent choice of modified cellulose. HPMC is fully degradable and compostable, making it a strong candidate to replace poorly biodegradable plastic coatings that dominate the industry today. The HPMC grade—E5 Premium LV from Dupont has important characteristics. The relatively low molecular weight of E5 Premium LV HPMC suppresses the viscoelastic behavior. The apparent viscosity of E5 Premium LV as a 2% solution in water at 20° C. ranges from 4-6 centipoise. A higher solid product can be attained at a relatively low viscosity.

Hyroxypropylmethyl cellulose of the E5 Premium LV grade is sufficient to provide hydrophobicity and reactive sites for esterification with naturally occurring short-chain organic acids. The methoxyl content of E5 premium LV ranges from 28-30 mole % while the hydroxypropoxyl content ranges from 7-12 mole %.

Suitable naturally occurring organic acids include those that have two or more carboxylic acid groups that can be used to cross-link the hydroxy group with the HPMC and paper substrate. Examples of naturally occurring organic acids include, for example, but are not limited to, citric acid, malic acid, maleic acid, tartaric, ascorbic acid, or combinations thereof. The organic acid may be extracted or derived from fruits, vegetables, or spices which may include, but are not limited to, apples, apricots, blackberries, blueberries, cherries, grapes, mirabelles, peaches, pears, plums, quince, lemons, limes, tangerines, oranges, grapefruits, pineapples, tomatoes, broccoli, or carrots.

Cross-linking may be controlled via selection of the mass (or molar) ratio of the components. The mass (or molar) ratio of modified cellulose to organic acid can range from 10:1 to 1:10, or any of a variety of sub-ranges between 10:1 and 1:10, including, for example, but not limited to, 8:2 to 2:9, 7:5 to 9:1, 2:1 to 2:2, 9:1 to 1:9, 2.75:1 to 8.999:2.05. The overall concentration of the blended components of modified cellulose and organic acid can range from a 1% to 50% or any of a variety of sub ranges between 1% to 50%, solution by mass, including but not limited to, for example, 1.89% to 43.999%, 1.875% to 2.185%, 2% to 49%, 25% to 26%, solution by mass, where all values are based on total mass of a composition including the modified cellulose and organic acid. Cross-linking via esterification or other reactions results in covalent bonds between the modified cellulose and cellulose in the substrate.

When modified cellulose and organic acid(s) are mixed with water to form an aqueous mixture, both species hydrate within the aqueous phase. When this aqueous mixture is coated onto a sheet, both species may be individually present and unreactive at ambient temperature and pressure. As part of the paper-making process, the coated sheet is heated, typically in a dryer section including a dryer, e.g., a Yankee dryer. Heating drives off water from the sheet. For the coating to exhibit acceptable barrier properties, the water must be driven from the coating and the esterification reaction will commence. The kinetics and extent of the esterification reaction is determined by the choice of organic acid and temperature and in some cases, the presence of catalyst. For optimum esterification, the temperature must surpass the melt point temperature of the organic acid. Cross-linking via esterification or other reactions may promote oleophobic and hydrophobic characteristics to the resulting paper sheet. Cross-linking acids are selected via the criteria below.

Melt-point of suitable organic acids must be elevated such that they are substantially unreactive with modified cellulose at ambient temperatures in aqueous solution form. Melt-point must be lower than the temperature of dryer section of a paper machine for sufficient esterification or other reaction between the modified cellulose and acid during the short on-machine curing time available with existing paper and paperboard machines. Suitable melt-point range for the organic acids with two or more carboxylic acid moieties would be 100 to 200° C.

Examples of suitable acids include but are not limited to:
Citric acid: m.p.˜153° C.
Malic acid: m.p.˜130° C.
Maleic acid: m.p.˜130° C.
Tartaric acid: m.p.˜170° C.
Ascorbic acid: m.p.˜190° C.

Specific grades of HPMC (Hydroxypropyl Methylcellulose) may be particularly advantageous to impart film barrier properties to a paper sheet or substrate. E5 Premium LV grade of HPMC from Dupont can be used at higher concentrations compared to other (higher molecular weight) grades of HPMCs from DuPont (e.g., 240S, F4M PRG or K15MS). The other grades of HPMC can reach gel viscosities at low solids concentrations of ca. 5 wt. %. The E5 Premium LV grade of HPMC will reach a gel point viscosity at approximately ca. 25 wt %. Dispersions of E5 Premium LV are flowable at ca. <20 wt % for commercial paper coating applications.

One challenge with modified cellulose is achieving enough coat weight on the paper sheet during the coating process. This is because the low solids (1-3 wt. %) result in little dry pickup onto the paper sheet, typically around one GSM coat weight or less. To increase dry pickup, it is necessary to increase the solids. The ideal grade of HPMC for this purpose is E5 Premium LV. In several variations, the product produced after cross-linking has a Kit Value of 8 or greater as measured per TAPPI T559 standard.

In a number of variations, when the aqueous mixture of modified cellulose and organic acid on a cellulose substrate (e.g. paper) is dried in an oven, the resultant product may have a Kit Value of 5 or greater.

In a number of variations, a method may include the acts of depositing, on a substrate comprising cellulose, an aqueous mixture comprising modified cellulose polymer molecules and organic acid molecules comprising at least two carboxyl acid groups; and removing water from the mixture deposited on the substrate to provide a coating on the substrate; wherein the organic acid molecules have a melting point above ambient temperature, and wherein the organic acid molecules are cross-linkable with the modified cellulose polymer molecules and the cellulose at or above the melting point of the organic acid molecules. In a number of variations the organic acid molecules are cross-linkable with the modified cellulose polymer molecules and the cellulose at a temperature ranging from ambient to 200° C.

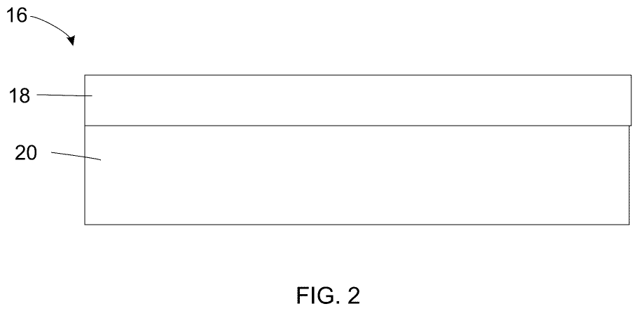

FIG. 2 illustrates a product 16, which may include a substrate 18 having a cross-linked coating 20 thereon, the substrate comprising cellulose, the cross-linked coating being the cross-linked reaction product of modified cellulose polymer molecules, organic acid molecules, and the cellulose, wherein the organic acid molecules comprising at least two carboxyl acid.

In a number of variations, cellulose ethers may be cross-linked with di-carboxylic acid. The cellulose ethers may include, but are not limited to, hydroxypropyl methyl cellulose, carboxy methyl cellulose, ethyl cellulose, or methyl cellulose.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a method comprising: depositing, on a substrate comprising cellulose, an aqueous mixture comprising modified cellulose polymer molecules and organic acid molecules comprising at least two carboxyl acid groups; removing water from the mixture deposited on the substrate to provide a coating on the substrate; wherein the organic acid molecules have a melting point above ambient temperature, and wherein the organic acid molecules are cross-linkable with the modified cellulose polymer molecules and the cellulose at or above ambient temperature. The kinetics and extent of esterification increase as the melt point temperature of the organic acid is reached.

Variation 2 may include a method as set forth in Variation 1 wherein the organic acid molecules have a melting point above about 130° C.

Variation 3 may include a method as set forth in any of Variations 1-2 wherein a molar or mass ratio of the modified cellulose polymer molecules to organic acid molecules ranges from about 10:1 to 1:10.

Variation 4 may include a method as set forth in any of Variations 1-3 wherein the organic acid molecules are naturally occurring.

Variation 5 may include a method as set forth in any of Variations 1-4 wherein the organic acid molecules comprise at least one of citric acid, malic acid, maleic acid, tartaric acid, or ascorbic acid.

Variation 6 may include a method as set forth in any of Variations 1-5 wherein the modified cellulose polymer molecules have an apparent viscosity of about 4.0 to 6.0 millipascal second in about 2% water at about 20° C.

Variation 7 may include a method as set forth in any of Variations 1-6 further comprising heating the substrate having the coating on the substrate to drive off water subsequently enabling the organic acid molecules to cross link the modified cellulose polymer molecules with at least one of organic acid molecules, or cellulose, to provide a cross-linked coating on the substrate.

Variation 8 may include a method set forth in any of Variations 1-7 wherein the cross-linked coating on the substrate provides a barrier with a TAPPI T-559 standard kit test value of about 5 or greater.

Variation 9 may include a product comprising: a substrate having a cross-linked coating thereon, the substrate comprising cellulose, the cross-linked coating being the cross-linked reaction product of modified cellulose polymer molecules, organic acid molecules, and the cellulose, wherein the organic acid molecules comprising at least two carboxyl acid.

Variation 10 product as set forth in Variation 9 wherein the organic acid molecules are naturally occurring.

Variation 11 may include a product as set forth in any one of Variations 9-10 wherein the organic acid molecules comprise at least one of citric acid, malic acid, maleic acid, tartaric acid, or ascorbic acid.

Variation 12 may include a product set forth in any one of Variations 9-11 wherein the cross-linked coating on the substrate provides a barrier with a TAPPI T-559 standard kit test value of about 5 or greater.

Variation 13 may include a product comprising: an aqueous mixture comprising modified cellulose polymer molecules and organic acid molecules comprising at least two carboxyl acid groups on a substrate comprising cellulose, and wherein the organic acid molecules have a melting point above ambient temperature, and wherein the organic acid molecules have a cross-linking property with the modified cellulose polymer molecules and cellulose at or above room temperature with favorable instantaneous cross-linking kinetics at or above the melting point of the organic acid molecules.

Variation 14 may include a product as set forth in Variation 13 wherein the organic acid molecules have a melting point above about 130° C.

Variation 15 may include a product as set forth in any one of Variations 13-14 wherein the modified cellulose polymer molecules to organic acid molecules have a molar or mass ratio ranges from about 10:1 to 1:10.

Variation 16 may include a product as set forth in any one of Variations 13-15 wherein the organic acid molecules are naturally occurring.

Variation 17 may include a product as set forth in any one of Variations 13-16 wherein the organic acid molecules comprise at least one of citric acid, malic acid, maleic acid, tartaric acid, or ascorbic acid.

Variation 18 may include a product as set forth in any one of Variations 13-17 wherein the organic acid molecules comprise citric acid.

Variation 19 may include a product as set forth in any one of Variations 13-18 wherein the modified cellulose polymer molecules have an apparent viscosity of about 4.0 to 6.0 millipascal second in about 2% water at about 20° C.

Variation 20 may include a product as set forth in any one of Variations 13-19 wherein the modified cellulose polymer molecules have a methoxyl content of about 28.0-30.0% and hydroxypropyl content of about 7.0-12.0%.

### Example 1

To a clean cylindrical container equipped with baffles and an overhead mixer (fitted with a pitch blade turbine impeller), the following ingredients are added at room temperature and mixed for one hour:
DI water=84 grams
Hydroxypropyl methylcellulose (HPMC; E5 or F50 grade): 8 to 16 grams
Organic Acid (citric, malic, ascorbic acid): 4 to 9 grams

The resulting solution is then filtered through a 400-micron sieve and used as a surface coating. A rod coater is employed where a 5″×5″ square sheet of paper is coated at room temperature once to attain approximately 5 g/m2 of dry coat weight onto the paper sheet. The paper is dried in the oven for approximately one minute at a pre-defined temperature and the TAPPI T559 standard kit test method was employed.

| | Oven | |
|---|---|---|
| | Temperature | Kit* |
| Sample Description | (° C.) | Value |
| Uncoated base sheet (30 GSM basis weight) | 175 | 0 |
| Uncoated base sheet (45 GSM basis weight) | 175 | 0 |
| Uncoated base sheet (90 GSM basis weight) | 175 | 0 |
| Uncoated base sheet (250 GSM basis weight) | 175 | 0 |
| Base sheet (90 GSM basis weight) coated with | 175 | 0 |
| HPMC (F50) | | |
| Base sheet (90 GSM basis weight) coated with E5 | 175 | 2 |
| HPMC (E5) | | |
| Base sheet (90 GSM basis weight) coated with | 175 | 5 |
| HPMC (F50) and citric acid | | |
| Base sheet (90 GSM basis weight) coated with | 175 | 8 |
| HPMC (E5) and citric acid | | |
| Base sheet (90 GSM basis weight) coated with | 120 | 2 |
| HPMC (F50) and citric acid | | |
| Base sheet (90 GSM basis weight) coated with | 120 | 1 |
| HPMC (E5) and maleic acid | | |
| Base sheet (90 GSM basis weight) coated with | 150 | 8 |
| HPMC (E5) and malic acid | | |
| Base sheet (90 GSM basis weight) coated with | 190 | 7 |
| HPMC (E5) and tartaric acid | | |
| Base sheet (90 GSM basis weight) coated with | 190 | 8 |
| HPMC (E5) and ascorbic acid | | |
| Base sheet (30 GSM basis weight) coated with | 175 | 8 |
| HPMC (E5) and citric acid | | |
| Base sheet (45 GSM basis weight) coated with | 175 | 9 |
| HPMC (E5) and citric acid | | |
| Base sheet (250 GSM basis weight) coated with | 175 | 10 |
| HPMC (E5) and citric acid | | |

*KIT Value: Measures the degree of oil and grease repellency of paper or paperboard which has been treated with sizing agents (refer to TAPPI - T559 Standard).

### Example 2

The uncoated and coated sheets were evaluated via the TAPPI T462 standard (the most current version as of the filing date of this application) method to determine oil hold-out. Cross-linking the organic acid with (E5 Premium LV) HPMC into the sheet yielded superior results.

| | Cobb Castor |
|---|---|
| | Oil Holdout |
| Sample Description | (2 mins) |
| Uncoated base sheet (90 GSM basis weight) | 90 |
| Base sheet (90 GSM basis weight) coated with HPMC | 70 |
| (F50) | |
| Base sheet (90 GSM basis weight) coated with E5 HPMC | 24 |
| (E5) | |
| Base sheet (90 GSM basis weight) coated with HPMC | 16 |
| (F50) and citric acid | |
| Base sheet (90 GSM basis weight) coated with HPMC | 7 |
| (E5) and citric acid | |

### Example 3

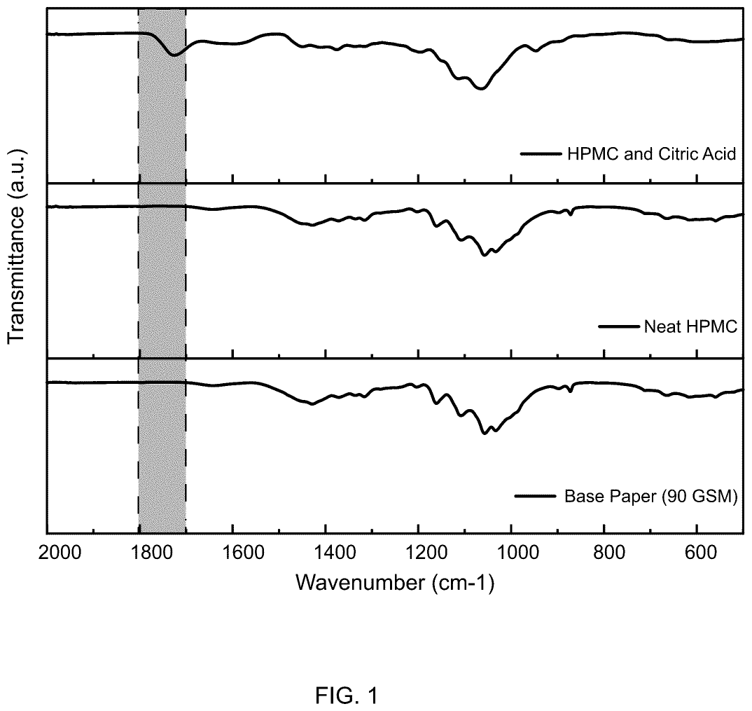

The uncoated paper was compared to the paper coated with (E5) HPMC and (E5) HPMC+citric acid. The esterification between the paper, citric acid and HPMC is noted via ATR-FTIR of the sheets as shown in FIG. 1.

In a number of variations, the (dry) coat weight on the paper sheet is from 3-8 g/m² (GSM) as measured using TAPPI standard method T550 (the most current version as of the filing date of this application). In essence, this method measures the weight difference between moisture-free uncoated and coated paper sheets. The concentration of HPMC and acid in solutions are fixed. In a number of variation additional components may be added to the composition including HPMC and organic acid including, but not limited to, fillers (e.g., talc, kaolin, bentonite, MMT); surfactants (e.g., DOSS); biocides (e.g., MIT/CIT/Bronopol); sizing chemistry (e.g., AKD, ASA, Rosin, starch); co-additives (e.g., micro-cellulose, nano-cellulose, sulfonated lignin).

### Example 4

A study was conducted to determine the performance of other cellulose ethers and blend of cellulous ethers. The total solids of HPMC and MC were kept constant: 16 wt % of cellulose ether and 9 wt % of citric acid in the DPT 1217 formulation. The approximate basis weight of the paper sheet was 29 GSM. In all the cases the raw materials were obtained from Sigma Aldrich and of technical grade in purity. The KIT test was performed to evaluate the Oil and Grease Resistance (OGR) performance on the coated sheets. In all cases, solutions at 25% total were made. The weight percent of cellulose ether was 16% and the acid type was citric acid.

The formulation coat weights achieved (in GSM) via the Dixon coater.

| | | Wt % of | Coat Wt. | KIT |
|---|---|---|---|---|
| Formulation | Cellulose Ether | Acid | (GSM) | Value |
| DPT 1217-Control | HPMC | 9% | ~5 | 10 |
| DPT 1217-Modified1 | HPMC | 9% | ~3 | 8 |
| DPT 1217-Modified2 | HPMC/MC75/25 | 16% | ~4 | 9 |
| DPT 1217-Modified3 | HPMC/MC50/50 | 16% | ~4 | 9 |
| DPT 1217-Modified4 | HPMC/MC25/75 | 16% | ~4 | 7 |
| DPT 1217-Modified5 | MC | 9% | ~3 | 6 |

This study suggests that cellulose ethers ca., both HPMC and MC, can cross-link with naturally occurring di-carboxylic acids such as citric acid to result in an oil and grease resistant barrier on the paper and paper-based substrate.

The above description of select examples within the scope of the invention are merely illustrative in nature and, thus, variations or variants thereof are not to be regarded as a departure from the spirit and scope of the invention.

1. A method comprising:
depositing, on a substrate comprising cellulose, an aqueous mixture comprising a modified cellulose polymer molecules and organic acid molecules comprising at least two carboxyl acid groups;
removing water from the mixture deposited on the substrate to provide a coating on the substrate;
wherein the organic acid molecules have a melting point above ambient temperature, and wherein the organic acid molecules are cross-linkable with the modified cellulose polymer molecules and the cellulose at or above ambient temperatures.

2. The method as set forth in claim 1 wherein the organic acid molecules have a melting point above about 130° C.

3. The method as set forth in claim 1 wherein a molar or mass ratio of the modified cellulose polymer molecules to organic acid molecules ranges from about 10:1 to 1:10.

4. The method as set forth in claim 1 wherein the organic acid molecules are naturally occurring.

5. The method as set forth in claim 1 wherein the organic acid molecules comprise at least one of citric acid, malic acid, maleic acid, tartaric acid, or ascorbic acid.

6. The method as set forth in claim 1 wherein the modified cellulose polymer molecules have an apparent viscosity of about 4.0 to 6.0 millipascal second in about 2% water at about 20° C.

7. The method of claim 1, further comprising heating the substrate having the coating on the substrate to a temperature of at least the melting point of the organic acid to cross link the modified cellulose polymer molecules, with at least one of organic acid molecules or cellulose, to provide a cross-linked coating on the substrate.

8. The method as set forth in claim 7 wherein the cross-linked coating on the substrate provides a barrier having a TAPPI 559 standard kit test value of about 5 or greater.

9. A product comprising:
a substrate having a cross-linked coating thereon, the substrate comprising cellulose, the cross-linked coating being the cross-linked reaction product of a modified cellulose polymer molecules, organic acid molecules, and the cellulose, wherein the organic acid molecules comprising at least two carboxyl acid.

10. The product as set forth in claim 9 wherein the organic acid molecules are naturally occurring.

11. The product as set forth in claim 9 wherein the organic acid molecules comprise at least one of citric acid, malic acid, maleic acid, tartaric acid, or ascorbic acid.

12. The method as set forth in claim 9 wherein the cross-linked coating on the substrate provides a barrier having a TAPPI 559 standard Kit test value of about 5 or greater.

13. A product comprising:
an aqueous mixture comprising a modified cellulose polymer molecules and organic acid molecules comprising at least two carboxyl acid groups on a substrate comprising cellulose, and wherein the organic acid molecules have a melting point above ambient temperature, and wherein the organic acid molecules have a cross linking property with the modified cellulose polymer molecules and cellulose at or above the melting point of the organic acid molecules.

14. The product as set forth in claim 13 wherein the organic acid molecules have a melting point above about 130° C.

15. The product as set forth in claim 13 wherein the modified cellulose polymer molecules to organic acid molecules have a molar or mass ratio range from about 10:1 to 1:10.

16. The product as set forth in claim 13 wherein the organic acid molecules comprise at least one of citric acid, malic acid, maleic acid, tartaric acid, or ascorbic acid.

17. The product as set forth in claim 13 wherein the organic acid molecules comprise citric acid.

18. The product as set forth in claim 13 wherein the modified cellulose polymer molecules have an apparent viscosity of about 4.0 to 6.0 millipascal second in about 2% water at about 20° C.

19. The product as set forth in claim 13 wherein the modified cellulose polymer molecules have a methoxyl content of about 28.0-30.0% and hydroxypropyl content of about 7.0-12.0%.

20. The method as set forth in claim 1 wherein the modified cellulose comprises at least one of hydroxyethyl cellulose polymer molecules, hydroxypropyl cellulose polymer molecules, methyl cellulose polymer molecules, hydroxypropyl methylcellulose polymer molecules or derivates thereof.
